(19) United States
(12) Patent Application Publication
(10) Pub. No.: US 2026/0364795 A1
(43) Pub. Date: Nov. 19, 2026

(54) DEVICE AND METHOD FOR CONTROLLING OPERATION OF ROBOT, DEVICE AND METHOD FOR GENERATING OPERATION PROGRAM, COMPUTER PROGRAM, AND OPERATION PROGRAM

(71) Applicant: FANUC CORPORATION, Minamitsuru-gun, Yamanashi (JP)

(72) Inventors: Motoyuki TANAKA, Oshino-mura, Minamitsuru-gun (JP); Tsuyoshi HANNYA, Oshino-mura, Minamitsuru-gun (JP)

(73) Assignee: FANUC CORPORATION, Minamitsuru-gun, Yamanashi (JP)

(21) Appl. No.: 19/475,559

(22) PCT Filed: Apr. 24, 2023
(86) PCT No.: PCT/JP2023/016167

§ 371 Date: Oct. 15, 2025

(51) Int. Cl. B25J 9/16; B25J 13/08

(52) U.S. Cl. CPC B25J 9/1664; B25J 9/1674; B25J 13/085

(57) ABSTRACT

Conventionally, an operation of a robot having a plurality of degrees of freedom may become unstable, which is caused by a singularity or the like.

The present invention provides a device for controlling the operation of the robot, the device comprising: an input reception unit that receives input specifying one of a first control method which achieves an operation of a plurality of degrees of freedom or a second control method which achieves an operation lower in degree of freedom by one or more degrees than the first control method and has a predetermined condition for permitting the operation achieved by the second control; an operation command unit that causes the robot to carry out the operation achieved by the first control method or the second control method specified by the input received by the input reception unit; and a condition determination unit that determines whether or not the condition is satisfied when the operation command unit executes the operation achieved by the second control method. When the condition determination unit determines that the condition is not satisfied, the operation command unit does not execute the operation achieved by the second control method.

### TECHNICAL FIELD

The present disclosure relates to a device and a method of controlling operation of a robot, a device and a method of generating an operation program, a computer program, and an operation program.

### BACKGROUND ART

There is a known technique for switching between a 5-axis control program and a 6-axis control program when executing an operation program causing a robot to execute work (e.g., Patent Literature 1).

### CITATION LIST

### Patent Literature

PTL 1: JP 2005-329521 A

### SUMMARY OF INVENTION

### Technical Problem

In the related art, operation of a robot with multiple degrees of freedom may be unstable due to a singular point or the like. Also when a control method is switched during execution of one operation program, the operation of the robot may be unstable.

### Solution to Problem

In one aspect of the present disclosure, a device configured to control operation of a robot having multiple degrees of freedom includes: an input receiving unit configured to receive an input for designating one of a first control method enabling the operation with multiple degrees of freedom and a second control method enabling the operation with one or more fewer degrees of freedom than those of the first control method, a condition for permitting the operation by the second control method being predefined; an operation command unit configured to cause the robot to execute the operation by the first control method or the second control method designated by the input received by the input receiving unit; and a condition determination unit configured to determine whether or not the condition is satisfied when the operation command unit executes the operation by the second control method. The operation command unit does not execute the operation by the second control method when the condition determination unit determines that the condition is not satisfied.

In another aspect of the present disclosure, a device configured to generate an operation program defining operation of a robot having multiple degrees of freedom includes: an input receiving unit configured to receive an input for designating one of a first control method enabling the operation with multiple degrees of freedom and a second control method enabling the operation with one or more fewer degrees of freedom than those of the first control method; and a program setting unit configured to designate one of the first control method and the second control method in the operation program in response to the input received by the input receiving unit. This operation program causes the robot to execute the operation by the first control method or the second control method designated by the program setting unit.

A method of controlling operation of a robot having multiple degrees of freedom includes: receiving, by a processor, an input for designating one of a first control method enabling the operation with multiple degrees of freedom and a second control method enabling the operation with one or more fewer degrees of freedom than those of the first control method, a condition for permitting the operation by the second control method being predefined; causing, by the processor, the robot to execute the operation by the first control method or the second control method designated by the received input; determining, by the processor, whether or not the condition is satisfied when executing the operation by the second control method; and not executing, by the processor, the operation by the second control method when determining that the condition is not satisfied.

A method of generating an operation program defining operation of a robot having multiple degrees of freedom includes: receiving, by a processor, an input for designating one of a first control method enabling the operation with multiple degrees of freedom and a second control method enabling the operation with one or more fewer degrees of freedom than those of the first control method; and designating, by the processor, one of the first control method and the second control method in the operation program in response to the received input. This operation program causes the robot to execute the operation by the first control method or the second control method designated.

An operation program defining operation of a robot having multiple degrees of freedom and causing the robot to execute the operation is configured such that one of a first control method enabling the operation with multiple degrees of freedom and a second control method enabling the operation with one or more fewer degrees of freedom than those of the first control method is to be designated. The operation program causes the robot to execute the operation by the first control method or the second control method designated therein.

### BRIEF DESCRIPTION OF DRAWINGS

FIG. 1 is a schematic view of a robot system according to an embodiment.

FIG. 2 is a block diagram of the robot system illustrated in FIG. 1.

FIG. 3 shows an example of a teaching flow executed by the robot system illustrated in FIG. 1.

FIG. 4 is a flowchart illustrating an example of a flow of step S2 in FIG. 3.

FIG. 5 illustrates an example of a data structure of an operation program.

FIG. 6 is a flowchart illustrating an example of a flow of step S3 in FIG. 3.

FIG. 7 is a block diagram illustrating another function of the robot system illustrated in FIG. 1.

FIG. 8 is a flowchart illustrating another example of the flow of step S2 in FIG. 3.

FIG. 9 is a block diagram of an operation program generation device according to an embodiment.

FIG. 10 is a flowchart illustrating an example of an operation check flow executed by the robot system illustrated in FIG. 7.

FIG. 11 is a flowchart illustrating an example of a flow of steps S43 and S44 in FIG. 3.

FIG. 12 is a flowchart illustrating still another example of the flow of step S2 in FIG. 3.

FIG. 13 is a flowchart illustrating another example of the flow of steps S43 and S44 in FIG. 10.

### DESCRIPTION OF EMBODIMENTS

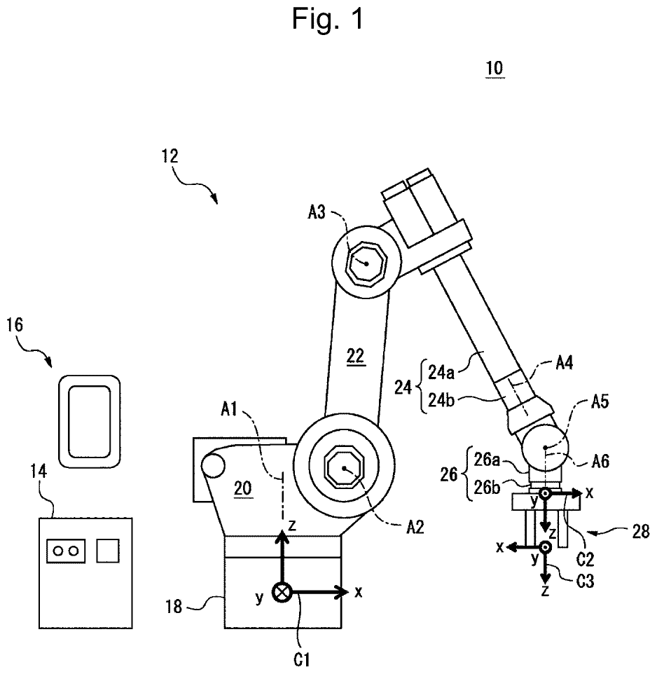

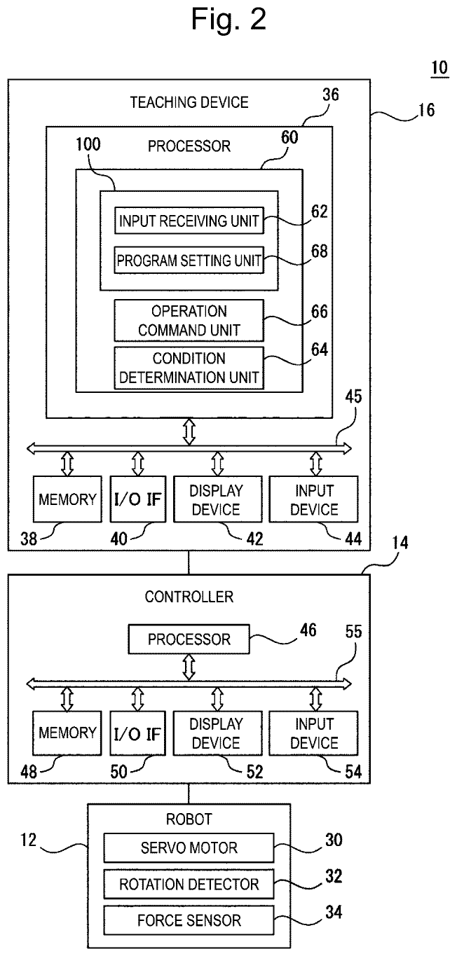

Embodiments of the present disclosure will be described in detail below with reference to the drawings. In the various embodiments described below, similar elements are denoted by the same reference signs, and duplicate descriptions will be omitted. First, a robot system 10 according to an embodiment will be described with reference to FIGS. 1 and 2. The robot system 10 includes a robot 12, a controller 14, and a teaching device 16.

In the present embodiment, the robot 12 is a vertical articulated robot, and performs predetermined work (e.g., workpiece handling, welding, cutting, or laser machining) on a workpiece (not illustrated). Specifically, the robot 12 includes a robot base 18, a swivel body 20, a lower arm 22, an upper arm 24, a wrist 26, and an end effector 28.

The robot base 18 is fixed on the floor of a work cell or an automated guided vehicle (AGV). The swivel body 20 is provided at the robot base 18 so as to be rotatable around a first joint shaft A1. The first joint shaft A1 is, for example, parallel to the vertical direction and fixed to the swivel body 20. The lower arm 22 is provided at the swivel body 20 so as to be pivotable around a second joint shaft A2. The second joint shaft A2 is orthogonal to the first joint shaft A1 (i.e., parallel to the horizontal direction) and fixed to the proximal end of the lower arm 22.

The upper arm 24 includes a proximal end arm 24a and a distal end arm 24b. The proximal end arm 24a is provided at the distal end of the lower arm 22 so as to be pivotable around a third joint shaft A3. The third joint shaft A3 is parallel to the second joint shaft A2 and is fixed to the proximal end of the proximal end arm 24a. The distal end arm 24b is provided at the distal end of the proximal end arm 24a so as to be pivotable around a fourth joint shaft A4. The fourth joint shaft A4 is orthogonal to the third joint shaft A3 and is fixed to the proximal end of the distal end arm 24b.

The wrist 26 includes a wrist base 26a and a wrist flange 26b. The wrist base 26a is provided at the distal end of the distal end arm 24b so as to be pivotable around a fifth joint shaft A5. The fifth joint shaft A5 is orthogonal to the fourth joint shaft A4 and fixed to the wrist base 26a. The wrist flange 26b is provided at the wrist base 26a so as to be pivotable around a sixth joint shaft A6. The sixth joint shaft A6 is orthogonal to the fifth joint shaft A5 and fixed to the wrist flange 26b. The end effector 28 is detachably attached to the wrist flange 26b. The end effector 28 is, for example, a robot hand, a welding torch, a cutting tool, or a laser machining head, and performs work (workpiece handling, welding, cutting, or laser machining) on a workpiece.

A servo motor 30 (FIG. 2) is coupled to each of the joint shafts Al to A6. These servo motors 30 rotationally drive the respective joint shafts A1 to A6 in accordance with a command from the controller 14. This causes the swivel body 20, the lower arm 22, the proximal end arm 24a, the distal end arm 24b, the wrist base 26a, and the wrist flange 26b (i.e., the end effector 28) to pivot around the joint shafts A1 to A6, respectively. That is, in the present embodiment, the robot 12 has six degrees of freedom.

On the other hand, the servo motors 30 are provided with respective rotation detectors 32 (FIG. 2) configured to detect rotational positions R1 to R6 (in other words, the rotational position of each servo motor 30) of the joint shafts A1 to A6. The rotation detector 32 includes, for example, an encoder or a Hall element, and supplies detection data Dr of the rotational positions R1 to R6 to the controller 14.

The robot 12 is provided with a force sensor 34 (FIG. 2) for detecting a force F applied to the robot 12. As an example, the force sensor 34 includes a 6 axis force sensor provided at any portion (e.g., the wrist 26 or the robot base 18) of the robot 12. As another example, the force sensor 34 includes a torque sensor provided in each of the joint shafts A1 to A6. The force sensor 34 supplies the controller 14 with the detection data Df of the force F having been detected.

As illustrated in FIG. 1, a robot coordinate system C1, a mechanical interface (MIF) coordinate system C2, and a tool coordinate system C3 are set at the robot 12. The robot coordinate system C1 is a fixed coordinate system for controlling the operation of each movable component (i.e., the swivel body 20, the lower arm 22, the proximal end arm 24a, the distal end arm 24b, the wrist base 26a, the wrist flange 26b, and the end effector 28) of the robot 12. In the present embodiment, the robot coordinate system C1 is set with respect to the robot base 18 such that the origin thereof is arranged at the center of the robot base 18 and a z axis thereof is parallel to (specifically, coincident with) the first joint shaft A1.

On the other hand, the MIF coordinate system C2 is a moving coordinate system that defines a position P of the hand-tip portion (specifically, the wrist flange 26b and the end effector 28) of the robot 12 at the robot coordinate system C1. In the present embodiment, the MIF coordinate system C2 is set with respect to the wrist flange 26b such that the origin thereof is arranged at the distal end surface center of the wrist flange 26b (i.e., the intersection of a virtual extension line of the sixth joint shaft A6 and the distal end surface of the wrist flange 26b), and the z axis thereof is parallel to (specifically, coincident with) the sixth joint shaft A6.

The tool coordinate system C3 is a moving coordinate system that defines the position P of the end effector 28 at the robot coordinate system C1 and is arranged in a known positional relationship with respect to the MIF coordinate system C2. In the present embodiment, the tool coordinate system C3 is set with respect to the end effector 28 such that the origin (what is called TCP) is arranged at the working position (e.g., a workpiece holding position, a welding position, a tool tip end point, or a laser beam emission port) of the end effector 28.

When the end effector 28 is moved, a processor 46 of the controller 14 sets the tool coordinate system C3 at the robot coordinate system C1 and generates a command to each servo motor 30 so as to position the end effector 28 at the position P represented by the tool coordinate system C3 having been set. Thus, the processor 46 drives each servo motor 30 and positions the end effector 28 at any position P at the robot coordinate system C1. In the present description, “position” may indicate a position and an orientation.

The teaching device 16 controls the operation of the robot 12 via the controller 14 and teaches the operation for work to the robot 12. As illustrated in FIG. 2, the teaching device 16 is a computer including a processor 36, a memory 38, an I/O interface 40, a display device 42, and an input device 44. The processor 36 includes a CPU or a GPU, is communicably connected to the memory 38, the I/O interface 40, the display device 42, and the input device 44 via a bus 45, and performs computational processing for implementing various functions described later while communicating with these components.

The memory 38 includes a RAM or a ROM, and transitorily or permanently stores various data. The memory 38 may be a computer-readable non-transitory recording medium such as a semiconductor memory, a magnetic recording medium, or an optical recording medium. The I/O interface 40 includes, for example, an Ethernet (registered trademark) port, a USB port, an optical fiber connector, or an HDMI (registered trademark) terminal, and communicates data with an external device by wire or wirelessly under a command from the processor 36.

The display device 42 includes a liquid crystal display, an organic EL display, or the like and visibly displays various data under a command from the processor 36. The input device 44 includes a touch panel, a press button, a switch, a keyboard, or a mouse and receives input of data from an operator. The display device 42 and the input device 44 may be integrally incorporated in the housing of the teaching device 16 or may be provided separately from the housing of the teaching device 16 and connected to the I/O interface 40. The teaching device 16 may be any type of computer such as a teach pendant or a laptop or tablet PC.

The controller 14 controls the operation of the robot 12. Specifically, the controller 14 is a computer including the processor 46, a memory 48, an I/O interface 50, a display device 52, and an input device 54. The configurations of the processor 46, the memory 48, the I/O interface 50, the display device 52, and the input device 54 are similar to those of the processor 36, the memory 38, the I/O interface 40, the display device 42, and the input device 44, and therefore duplicate descriptions will be omitted.

The processor 46 is communicably connected to the memory 48, the I/O interface 50, the display device 52, and the input device 54 via a bus 55, and performs computational processing for implementing a robot control function while communicating with these components. In the present embodiment, the I/O interface 50 is communicably connected to the I/O interface 40 of the teaching device 16.

The operator gives a teaching command Ct for teaching the operation of the robot 12 to the controller 14, and teaches a teaching point Pt for positioning the end effector 28 (or the origin of the tool coordinate system C3) at the time of work while moving the robot 12 (specifically, the end effector 28) to a desired direction. By operating the input device 44 of the teaching device 16, the operator gives the processor 36 of the teaching device 16 an input IN1 for selecting a jog teaching mode OM1, a lead-through teaching mode OM2, or the operation reproduction mode OM3 as an operation mode OM of the robot 12.

The processor 36 of the teaching device 16 transmits a mode selection command Cm to the controller 14 in response to the input IN1 received through the input device 44. The processor 46 of the controller 14 switches the operation mode OM of the robot 12 among the jog teaching mode OM1, the lead-through teaching mode OM2, and the operation reproduction mode OM3 in accordance with the mode selection command Cm.

In the jog teaching mode OM1, the operator operates the input device 44 of the teaching device 16 to input, as the teaching command Ct, a jog command Ct1 for causing the robot 12 to perform a jog operation. The processor 36 of the teaching device 16 receives an input IN7 of the jog command Ct1 and transmits, to the controller 14, the jog command Ct1 having been received. The processor 46 of the controller 14 causes the robot 12 to perform a jog operation in accordance with the jog command Ct1 having been received.

On the other hand, in the lead-through teaching mode OM2, the operator applies, as the teaching command Ct, a handling force Ct2 to any movable component (e.g., the end effector 28) of the robot 12. The processor 46 of the controller 14 computes, based on the detection data Df of the force sensor 34, the magnitude and direction of the handling force Ct2 of the operator and specifies the movable component applied with the handling force Ct2. The processor 46 executes a lead-through teaching function of moving the movable component applied with the handling force Ct2 to a direction of the handling force Ct2.

Thus, the processor 36 of the teaching device 16 controls the operation of the robot 12 via the controller 14 and creates an operation program OP of the robot 12 by teaching a plurality of the teaching points Ptₙ(n=1, 2, 3, . . . ). The operation program OP is a computer program configured to define the operation of the robot 12 for work. In the operation program OP, for example, the plurality of teaching points Ptₙ (specifically, a coordinate Qn of the robot coordinate system C1), a movement path MP of the robot 12 passing through the plurality of teaching points Ptₙ, a movement velocity V of the robot 12, and various operations of the robot 12 (positioning operation of the robot 12 to the plurality of teaching points Ptₙ, activation of the end effector 28, and the like) are defined as instruction codes IC.

The operation reproduction mode OM3 is the operation mode OM for performing an operation check of the operation program OP having been created. In the operation reproduction mode OM3, the processor 36 of the teaching device 16 (or the processor 46 of the controller 14) executes the operation program OP stored in the memory 38 (or the memory 48) at this time point, and causes the robot 12 to execute the operation defined in the operation program OP.

Here, in the present embodiment, the processor 36 or 46 operates the robot 12 in accordance with a first control method MT1 or a second control method MT2 during execution of the jog teaching mode OM1, the lead-through teaching mode OM2, or the operation reproduction mode OM3. The first control method MT1 is a control method MT enabling the operation of the robot 12 with six degrees of freedom and drives the six joint shafts A1 to A6.

The first control method MT1 is defined by a first control program (specifically, an inverse-kinematic algorithm of six degrees of freedom) CP1. The first control program CP1 is a program for obtaining the position P at the robot coordinate system C1 (specifically, coordinates of the MIF coordinate system C2 and the tool coordinate system C3 at the robot coordinate system C1) of the hand-tip portion of the robot 12 from the rotational positions R1 to R6 of the six joint shafts A1 to A6. The processor 36 or 46 enables the operation of the robot 12 by the first control method MT1 by using the first control program CP1.

On the other hand, the second control method MT2 is a control method MT enabling the operation of the robot 12 with one or more fewer degrees of freedom than those of the first control method MT. In the present embodiment, the second control method MT2 is a control method MT enabling the operation of the robot 12 with five degrees of freedom, and drives the five joint shafts A1, A2, A3, A5, and A6 among the total of six joint shafts A1 to A6, while fixing the joint shaft A4 at the rotational position R4=0°.

The second control method MT2 is defined by a second control program CP2 (specifically, an inverse-kinematic algorithm with five degrees of freedom). The second control program CP2 is a program for obtaining the position P at the robot coordinate system C1 (coordinates of the MIF coordinate system C2 and the tool coordinate system C3 at the robot coordinate system C1) of the hand-tip portion of the robot 12 from the rotational positions R1 to R3, R5, and R6 of the five joint shafts A1 to A3, A5, and A6. The processor 36 or 46 enables the operation of the robot 12 by the second control method MT2 by using the second control program CP2.

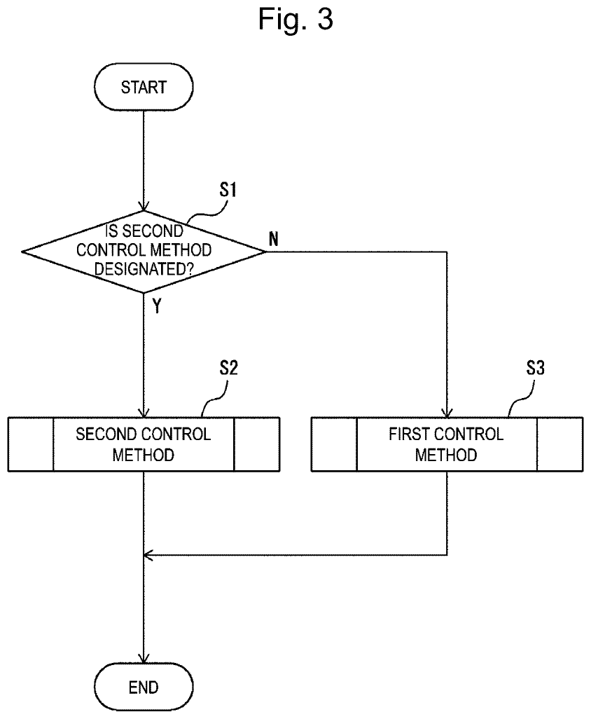

Next, a method of teaching the operation of the robot 12 in the jog teaching mode OM1 or the lead-through teaching mode OM2 will be described with reference to FIG. 3. The processor 36 of the teaching device 16 starts the flow illustrated in FIG. 3 when receiving a teaching start command from the operator, the higher-level controller, or a computer program PG1.

In step S1, the processor 36 determines whether or not an input IN2 for designating the second control method MT2 has been received. Specifically, the processor 36 generates and displays, on the display device 42, image data IM1 of a graphical user interface (GUI) for designating one of the first control method MT and the second control method MT2. While visually recognizing the image data IM1, the operator operates the input device 44 to give the processor 36 the input IN2 for designating one of the first control method MT and the second control method MT2.

The processor 36 determines YES if receiving the input IN2 for designating the second control method MT2 and proceeds to step S2 but determines NO if receiving the input IN2 for designating the first control method MT1 and proceeds to step S3. In this manner, in the present embodiment, the processor 36 functions as an input receiving unit 62 (FIG. 2) that receives the input IN2 for designating one of the first control method MT1 enabling the operation of the robot 12 with multiple degrees of freedom (six degrees of freedom in the present embodiment) and the second control method MT enabling the operation of the robot 12 with one or more fewer degrees of freedom than those of the first control method MT2 (five degrees of freedom in the present embodiment).

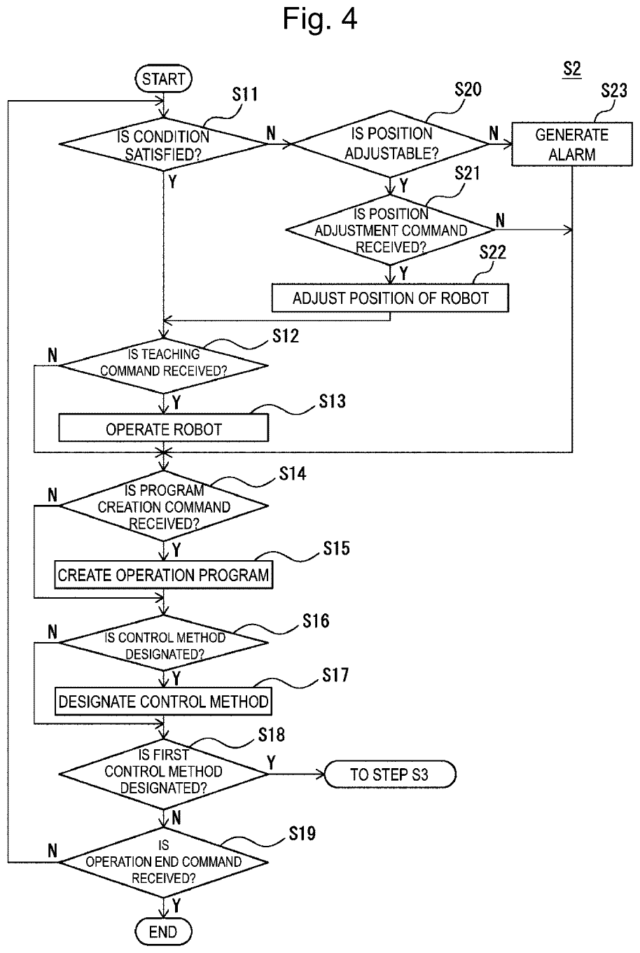

In step S2, the processor 36 executes a teaching process by the second control method MT2. This step S2 will be described with reference to FIG. 4. After the start of step S2, the processor 36 determines in step S11 whether or not a condition CD2 of the second control method MT2 is satisfied. This condition CD2 is for permitting the robot 12 to operate in accordance with the second control method MT2. In the present embodiment, the condition CD2 includes a condition for determining the position P of the robot 12 when the robot 12 is operated in the second control method MT2.

More specifically, the condition CD2 includes a condition CD2_{_1} that R4=0° for the rotational position R4 of the fourth joint shaft A4 (i.e., the distal end arm 24b) and a condition CD22 that the z axis direction (in other words, the direction of the sixth joint shaft A6) of the MIF coordinate system C2 is parallel to the vertical direction (i.e., the z axis direction of the robot coordinate system C1) or the horizontal direction (i.e., an x-y plane of the robot coordinate system C1). The processor 36 determines, based on the detection data Dr of the rotational position R4 of the fourth joint shaft A4 detected by the rotation detector 32 at this time point, whether or not the condition CD2_{_1} is satisfied.

The processor 36 obtains, based on the detection data Dr of the rotational positions R1 to R6 of the joint shafts A1 to A6 detected by the rotation detector 32 at this time point and the second control program CP2, coordinates QM (x, y, z, w, p, r) at the robot coordinate system C1 of the MIF coordinate system C2 at this time point. In the coordinates QM, the coordinates (x, y, z) indicate the position of the origin of the MIF coordinate system C2 at the robot coordinate system C1, and the coordinates (w, p, r) indicate the orientation (i.e., the direction of each axis) of the MIF coordinate system C2 at the robot coordinate system C1. The processor 36 determines, based on the coordinates (w, p, r) indicating the orientation among the coordinates QM, whether or not the condition CD2 2 is satisfied.

In step S11, the processor 36 determines YES if both of the conditions CD2_{_1} and CD2_{_2} are satisfied and proceeds to step S12 but determines NO if at least one of the conditions CD2_{_1} and CD2_{_2} is not satisfied and proceeds to step S20. In this manner, in the present embodiment, the processor 36 functions as a condition determination unit 64 (FIG. 2) that determines whether or not the condition CD2 (CD2_{_1} and CD2_{_2}) is satisfied.

In step S12, the processor 36 determines whether or not the teaching command Ct has been received. As an example, when the jog teaching mode OM1 described above is in execution, the processor 36 functions as the input receiving unit 62 to determine whether or not the input IN7 of the jog command Ct1 has been received through the input device 44 from the operator.

As another example, when the lead-through teaching mode OM2 described above is in execution, the processor 36 determines whether or not the processor 46 of the controller 14 has received the handling force Ct2. The processor 36 determines YES if receiving the teaching command Ct (the jog command Ct1 or the handling force Ct2) and proceeds to step S13 but proceeds to step S14 if determining NO.

In step S13, the processor 36 causes the robot 12 to execute the operation by the second control method MT2. Specifically, using the second control program CP2, the processor 36 causes the robot 12 to execute the operation with five degrees of freedom so that the robot 12 continuously satisfies the condition CD2_{_1} (R4=0°) and the condition CD2_{_2} (the z axis of the MIF coordinate system C2 is in the vertical direction or the horizontal direction) of the second control method MT2 in accordance with the teaching command Ct (the jog command Ct1 or the handling force Ct2) received in the immediately preceding step S12.

That is, in step S13, under the second control method MT2, the processor 36 moves the end effector 28 by operating the robot 12 in accordance with the teaching command Ct in a state of fixing the rotational position R4 of the fourth joint shaft A4 at R4=0° and maintaining the end effector 28 at an orientation in which the z axis of the MIF coordinate system C2 is parallel to the vertical direction or the horizontal direction.

More specifically, when the jog teaching mode OM1 is in execution, the processor 36 causes the robot 12 to operate via the controller 14 in accordance with the jog command Ct1 received in the immediately preceding step S12 while maintaining the robot 12 in a state of satisfying the conditions CD2_{_1} and CD2_{_2}. At this time, if the movement direction MD of the robot 12 by the jog command Ct1 is to move the robot 12 to the position P not satisfying the conditions CD2_{_1} and CD2_{_2}, the processor 36 may compute, based on a movement direction MD of the jog command Ct1, and move the robot 12 in the movement direction MD′, a movement direction MD′ that can satisfy the conditions CD2_{_1} and CD2_{_2}.

On the other hand, when the lead-through teaching mode OM2 is in execution, the processor 36 causes the processor 46 of the controller 14 to execute the lead-through teaching function of causing the robot 12 to operate in a direction MD of the handling force Ct2. If the direction MD of the handling force Ct2 is to move the robot 12 to the position P not satisfying the conditions CD2_{_1} and CD2_{_2}, the processor 36 may compute, based on the direction MD of the handling force Ct2, a direction MD′ that can satisfy the conditions CD2_{_1} and CD2_{_2} and cause the controller 14 to execute a lead-through teaching function of moving the robot 12 to the direction MD′. In this manner, the processor 36 functions as an operation command unit 66 (FIG. 2) that causes the robot 12 to execute the operation by the second control method MT2.

The processor 36 may move the end effector 28 by executing a linear motion LM in step S13. The linear motion LM is operation of moving the end effector 28 from a current position Pc to a target position Pg along the smooth (e.g., linear or arcuate) movement path MP with the minimum movement amount.

Alternatively, in step S13, the processor 36 may move the end effector 28 by executing an joint motion SM. The joint motion SM is a motion of rotating at least one joint shaft A (e.g., the fifth joint shaft A5) from a current rotational position Rc to a goal rotational position Rg with a minimum amount of rotation. The operator may select the linear motion LM or the joint motion SM by operating the input device 44, and the processor 36 may execute the linear motion LM or the joint motion SM having been selected.

In step S14, the processor 36 determines whether or not a program creation command Cr has been received. The program creation command Cr is a command for creating the operation program OP by storing the current position Pc of the robot 12 at this time point as the teaching point Ptₙ and designating the operation (e.g., movement of the end effector 28 to the teaching point Ptₙ) of the robot 12 at the teaching point Ptₙ.

Specifically, the processor 36 generates and displays, on the display device 42, image data IM2 of a GUI for inputting the program creation command Cr. The operator gives an input IN4 of the program creation command Cr to the processor 36 by operating the input device 44 while visually recognizing the image data IM2. When functioning as the input receiving unit 62 and if receiving the input IN4, the processor 36 determines YES and proceeds to step S15. On the other hand, if not receiving the input IN4, the processor 36 determines NO and proceeds to step S16.

In step S15, the processor 36 creates the operation program OP. Specifically, the processor 36 stores the current position Pc of the robot 12 at this time point (specifically, a coordinate Q_{T} at the robot coordinate system C1 of the tool coordinate system C3 at this time point) into a position database DB stored in the memory 38 as the teaching point Ptₙ in accordance with the program creation command Cr received in the immediately preceding step S14. The processor 36 writes, into the operation program OP, the instruction code IC referring to the teaching point Ptₙ stored in the position database DB. The processor 36 may directly write, into the operation program OP, the position data (the coordinate Q_{T}) of the teaching point Ptₙ as the instruction code IC.

The processor 36 writes, into the operation program OP, the instruction code IC that defines the operation of the robot 12 at the teaching point Ptₙ, the movement path MP, and the movement velocity V in accordance with the program creation command Cr. By repeatedly executing the flow of steps S12 to S15, the processor 36 creates an operation program OP1 in which the plurality of teaching points Ptₙ, the operation of the robot 12, the movement path MP, the movement velocity V, and the like are defined as the instruction codes IC.

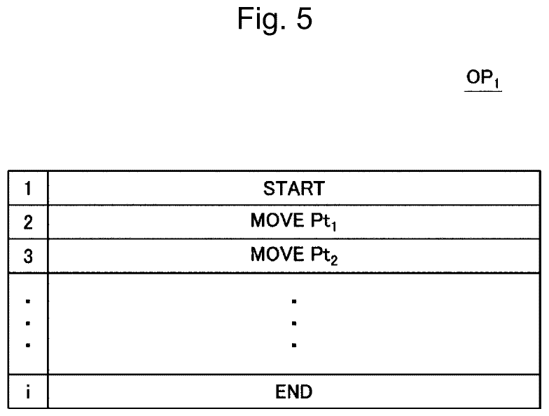

The operation program OP₁ to be created in step S2 enables the operation of the second control method MT2 (i.e., five degrees of freedom). FIG. 5 illustrates an example of the data structure of the operation program OP₁. In the example illustrated in FIG. 5, “START” in the first line is the instruction code IC that starts the operation program OP₁, while “END” in the i-th line is the instruction code IC that ends the operation program OP₁. “MOVE Pt₁” in the second line is the instruction code IC that defines the operation of positioning the end effector 28 at a first teaching point Pt₁.

Information Ir⁺indicating that the rotational position R (R5) of one joint shaft A (e.g., the fifth joint shaft A5) of the robot 12 is a non-negative value (i.e., R5≥0°) and information Ir⁻indicating that the rotational position R (R5) of the one joint shaft A (the fifth joint shaft A5) is a negative value (i.e., R5<0°) may be further defined for each teaching point Ptₙ of the operation program OP₁.

These pieces of information Ir⁺and Ir should be defined in the operation program OP for the operation of the robot 12 with six degrees of freedom, and are information necessary to uniquely determine the solutions of the rotational positions R1 to R6 of the joint shafts A1 to A6 of the robot 12 with six degrees of freedom in order to position the end effector 28 (i.e., the tool coordinate system C3) at any position at the robot coordinate system C1. In the present embodiment, the processor 36 also defines the information Ir⁺and Ir⁻for the operation with six degrees of freedom for each teaching point Ptₙ of the operation program OP₁ to be created by the second control method MT2. This configuration allows the robot 12 with six degrees of freedom to effectively execute the operation program OP₁ with five degrees of freedom.

In step S16, the processor 36 determines whether or not an input IN5 for designating one of the first control method MT1 and the second control method MT2 in the operation program OP₁ has been received. Specifically, the processor 36 generates and displays, on the display device 42, image data IM4 for designating one of the first control method MT and the second control method MT2 in the operation program OP₁.

The operator gives the processor 36 the input IN5 for designating the first control method MT or the second control method MT2 by operating the input device 44 while visually recognizing the image data IM4. When functioning as the input receiving unit 62 and if receiving the input IN5, the processor 36 determines YES and proceeds to step S17. On the other hand, if determining NO, the processor 36 proceeds to step S18.

In step S17, the processor 36 designates the first control method MT or the second control method MT2 in the operation program OP₁ created in step S15 in accordance with the input IN5 received in the immediately preceding step S16. Specifically, the processor 36 gives the operation program OP₁ a flag FG indicating designation of the first control method MT or the second control method MT2.

For example, in the immediately preceding step S16, the operator gives the input IN5 for designating the second control method MT2 to the operation program OP₁ defining the operation with five degrees of freedom. In this case, in step S17, the processor 36 gives the operation program OP₁ created in step S15 the flag FG indicating designation of the second control method MT2. In this manner, in the present embodiment, the processor 36 functions as a program setting unit 68 (FIG. 2) that designates one of the first control method MT1 and the second control method MT2 in the operation program OP₁ in response to the input IN5.

In step S18, the processor 36 determines whether or not an input IN6 for designating the first control method MT1 has been received. Specifically, the processor 36 displays the image data IM1 described above on the display device 42 and determines YES when functioning as the input receiving unit 62 and if receiving the input IN6 for designating the first control method MT1 through the input device 44. The processor 36 proceeds to step S3 in FIG. 3 if determining YES but proceeds to step S19 if determining NO.

In step S19, the processor 36 determines whether or not an operation end command has been received from the operator, the higher-level controller, or the computer program PG1. If receiving the operation end command, the processor 36 determines YES and ends the flow of FIG. 4 and ends the flow illustrated in FIG. 3. On the other hand, if determining NO, the processor 36 returns to step S11.

On the other hand, if determining NO in step S11, the processor 36 determines in step S20 whether or not the position P of the robot 12 is adjustable. It is assumed that NO is determined because the condition CD2_{_1} (R4=0°) is not satisfied in the immediately preceding step S11. In this case, the processor 36 determines whether or not the rotational position R4 of the fourth joint shaft A4 at this time point is within a predetermined allowable range [Rth1, Rth2] (i.e., Rth1 ≤R4≤Rth2). Threshold values Rth1 and Rth2 defining this allowable range [Rth1, Rth2] can be determined by the operator based on the condition CD2₁ (e.g., Rth1=−1°, Rth2=°). If Rth1≤R4≤Rth2, the processor 36 determines YES.

On the other hand, it is assumed that NO is determined because the condition CD2₂ (the z axis of the MIF coordinate system C2 is in the vertical direction or the horizontal direction) is not satisfied in the immediately preceding step S11. In this case, the processor 36 obtains an angle θ of the z axis direction of the MIF coordinate system C2 at this time point from the vertical direction or the horizontal direction. The processor 36 determines whether or not the angle θ is a predetermined threshold value 0th or less (i.e., 0≤th). This threshold value 0th can be determined by the operator based on the condition CD2_{_2} e.g., 0th=5°). If 0≤0th, the processor 36 determines YES.

If determining NO because both of the conditions CD2₁ and CD2₂ are not satisfied in the immediately preceding step S11, the processor 36 determines YES if Rth1≤R 4≤Rth2 and 0≤0th are satisfied in step S20. The processor 36 proceeds to step S21 if determining YES but proceeds to step S23 if determining NO.

In step S21, the processor 36 determines whether or not a position adjustment command Ca has been received. The position adjustment command Ca is a command for adjusting the position P of the robot 12 to a position P′ satisfying the condition CD2. More specifically, the processor 36 generates and displays, on the display device 42, image data IM3 of a GUI for inputting the position adjustment command Ca.

The operator gives an input IN3 of the position adjustment command Ca to the processor 36 by operating the input device 44 while visually recognizing the image data IM3. When functioning as the input receiving unit 62 and if receiving the input IN3 of the position adjustment command Ca, the processor 36 determines YES and proceeds to step S22. On the other hand, if not receiving the input IN3, the processor 36 determines NO and proceeds to step S14.

In step S22, the processor 36 functions as the operation command unit 66 to adjust the current position Pc of the robot 12 at this time point to the position P′ satisfying the condition CD2. Specifically, the processor 36 functions as the operation command unit 66 to operate the robot 12 via the controller 14 and position the end effector 28 at the position P′ satisfying the condition CD2_{_1} (R4=0°) and the condition CD2_{_2} (the z axis of the MIF coordinate system C2 is in the vertical direction or the horizontal direction).

At this time, the processor 36 may move the end effector 28 by executing the joint motion SM described above. Thus, the processor 36 adjusts the position P of the robot 12 so as to be brought into a state of satisfying the condition CD2. After step S22, the processor 36 proceeds to step S12. When executing step S22, the processor 36 may generate, as an image or audio, a notification signal NS indicating that the robot 12 is brought into a state of satisfying the condition CD2 and display it on the display device 42 or output it through a speaker (not illustrated) provided at the teaching device 16.

When the position Pc of the robot 12 is adjusted to the position P′ in step S22, the processor 36 may define the position P′ after adjustment as a new teaching point Ptₙ in the operation program OP1 and define, in the operation program OP1, the operation (e.g., the joint motion SM) of the robot 12 that moves the end effector 28 from the position Pc before adjustment to the position P′ after adjustment. As a result, the operation executed in step S22 can be taught by being defined as the instruction code IC in the operation program OP1.

If determining NO in step S20, the processor 36 generates an alarm AL1 in step S23. For example, the processor 36 generates and outputs, through the display device 42 or the speaker, the alarm AL1 of an image or audio that “The robot cannot be operated because the condition of the second control method is not satisfied.” After step S23, the processor 36 proceeds to step S14. In this manner, in the present embodiment, when the condition CD2 is not satisfied, the processor 36 does not execute in step S13 the operation of the robot 12 by the second control method MT2.

In step S23, the processor 36 may attach, to the alarm AL1, information specifying the condition CD2 determined to be NO in the latest step S11. For example, in the latest step S11, if determining NO because the condition CD2_{_1} that R4=0° is not satisfied, the processor 36 may attach, to the image or audio of the alarm AL1, information indicating that the condition CD2_{_1} is not satisfied.

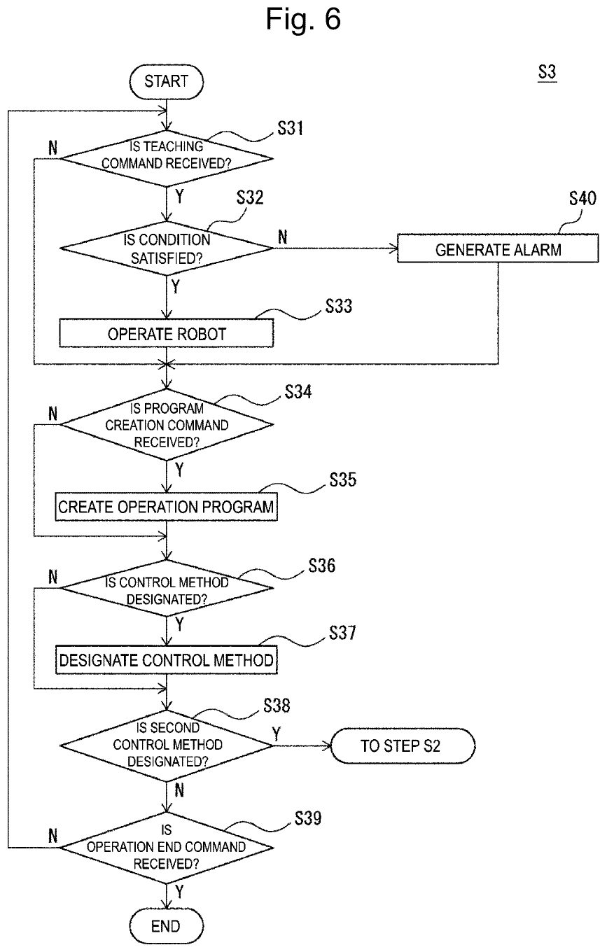

With reference to FIG. 3 again, if determining NO in step S1, the processor 36 executes in step S3 the teaching process by the first control method MT1. This step S3 will be described with reference to FIG. 6. In step S31 after the start of step S3, the processor 36 determines whether or not the teaching command Ct has been received similar to step S12 described above. The processor 36 proceeds to step S32 if determining YES but proceeds to step S34 if determining NO. In step S32, the processor 36 functions as the condition determination unit 64 and determines whether or not a condition CD1 for permitting the operation of the robot 12 by the first control method MT1 is satisfied. The condition CD1 includes, for example, a condition that the robot 12 does not pass near the singular point SP. The singular point SP is, for example, a position of the robot 12 at which two of the joint shafts Al to A6 are aligned on a straight line, and it is impossible to uniquely determine solutions of the rotational positions R1 to R6 of the joint shafts A1 to A6 for positioning the end effector 28 at such the singular point SP.

In step S32, the processor 36 computes the target position Pg of the robot 12 (specifically, the end effector 28) by the teaching command Ct received in the immediately preceding step S31 and determines whether or not the movement path MP of the robot 12 to the target position Pg passes near the singular point SP. The processor 36 determines YES if the movement path MP does not pass near the singular point SP and proceeds to step S33 and determines NO if the movement path MP passes near the singular point SP and proceeds to step S40.

In step S33, the processor 36 functions as the operation command unit 66 to cause the robot 12 to execute the operation by the first control method MT1. Specifically, using the first control program CP1, the processor 36 causes the robot 12 to execute the operation with six degrees of freedom in accordance with the teaching command Ct (the jog command Ct1 or the handling force Ct2) received in the latest step S31.

The processor 36 may move the end effector 28 by executing the linear motion LM or the joint motion SM in step S33. The operator may operate the input device 44 to select the linear motion LM or the joint motion SM, and the processor 36 may execute the linear motion LM or the joint motion SM having been selected. In step S34, the processor 36 determines whether or not the program creation command Cr has been received similar to step S14 described above. The processor 36 proceeds to step S35 if determining YES but proceeds to step S36 if determining NO. In step S35, similar to step S15 described above, the current position Pc of the robot 12 at this time point is stored in the position database DB as the teaching point Ptₙ, and the operation program OP₂ in which the teaching point Ptₙ is defined is created. The operation program OP₂ to be created in step S3 enables the operation of the first control method MT1 (i.e., six degrees of freedom).

The operation program OP₂ may be created as a computer program different from the operation program OP₂ with five degrees of freedom to be created in step S2 and includes the instruction codes IC from “START” to “END” similar to the operation program OP2 illustrated in FIG. 5. The operation program OP₂ defines the information Ir⁺and Ir⁻indicating the non-negativity or negativity of the joint shaft A described above.

In step S36, the processor 36 determines whether or not the input IN5 for designating one of the first control method MT1 and the second control method MT2 in the operation program OP has been received similar to step S16 described above. When functioning as the input receiving unit 62 to receive the input IN5, the processor 36 determines YES and proceeds to step S37 but if determining NO, proceeds to step S38.

In step S37, the processor 36 functions as the program setting unit 68 to designate, in response to the input IN5 received in the immediately preceding step S36, the first control method MT or the second control method MT2 in the operation program OP₂ created in step S35 similar to step S17 described above. For example, in the immediately preceding step S36, the operator gives the operation program OP₂ defining the operation with six degrees of freedom the input IN5 for designating the first control method MT1. In this case, in step S37, the processor 36 gives the operation program OP₂ created in step S35 the flag FG indicating designation of the first control method MT1.

In step S38, the processor 36 determines whether or not the input IN2 for designating the second control method MT2 has been received similar to step S1 described above. The processor 36 proceeds to step S2 in FIG. 3 if determining YES but proceeds to step S39 if determining NO. In step S39, the processor 36 determines whether or not the operation end command has been received similar to step S19 described above. The processor 36 ends the flow of FIG. 6 if determining YES, thereby ending the flow illustrated in FIG. 3. On the other hand, if determining NO, the processor 36 returns to step S31.

On the other hand, if determining NO in step S32, the processor 36 generates an alarm AL2 in step S40. For example, the processor 36 generates and outputs, through the display device 42 or the speaker, the alarm AL2 of an image or audio that “The robot cannot be operated because the condition of the first control method is not satisfied.”At this time, the processor 36 may attach, to the alarm AL2, information specifying the condition CD1 (passing near the singular point) determined to be NO in the immediately preceding step S32. After step S40, the processor 36 proceeds to step S34. In this manner, in the present embodiment, when the condition CD1 is not satisfied, the processor 36 does not execute the operation of the robot 12 by the first control method MT1 in step S33.

As described above, the processor 36 can create the plurality of operation programs OP₁, OP₂, OP₃, . . . by sequentially executing steps S2 and S3 in FIG. 3. Each of a plurality of operation programs OPₘ (m=1, 2, 3, . . . ) created in this manner has a data structure including the instruction codes IC from “START” to “END” as illustrated in FIG. 5, and a flag FL representing designation of the first control method MT or the second control method MT2 is given in step S17 or S37. The plurality of operation programs OPₘ having been created are stored in the memory 38 (or 48).

As described above, in the present embodiment, the processor 36 functions as the input receiving unit 62, the condition determination unit 64, the operation command unit 66, and the program setting unit 68 and controls the operation of the robot 12 having multiple degrees of freedom (specifically, six degrees of freedom). Therefore, the input receiving unit 62, the condition determination unit 64, the operation command unit 66, and the program setting unit 68 constitute a device 60 (FIG. 2) that controls the operation of the robot 12 with multiple degrees of freedom.

In this device 60, the input receiving unit 62 receives the inputs IN2 and IN6 for designating one of the first control method MT1 enabling the operation with multiple degrees of freedom (six degrees of freedom in the present embodiment) and the second control method MT2 enabling the operation with one or more fewer degrees of freedom than those of the first control method MT2 (five degrees of freedom in the present embodiment) (steps S1, S18, and S38). In the second control method MT2, the condition CD2 (specifically, CD2_{_1} and CD2_{_2}) for permitting the operation of the robot 12 by the second control method MT2 is predetermined.

The operation command unit 66 causes the robot 12 to execute the operation by the first control method MT1 or the second control method MT2 designated by the inputs IN2 and IN6 received by the input receiving unit 62 (steps S13 and S33). On the other hand, the condition determination unit 64 determines whether or not the condition CD2 is satisfied when the operation command unit 66 executes the operation by the second control method MT2 (step S11). When the condition determination unit 64 determines that the condition CD2 is not satisfied (determines NO in step S11), the operation command unit 66 does not execute the operation by the second control method MT2.

Here, in the operation of the robot 12 with multiple degrees of freedom (e.g., six degrees of freedom), the singular point SP described above is generated, and the operation of the robot 12 may become unstable when passing near the singular point SP. Such the singular point SP can be avoided by limiting the operation of the robot 12 to one or more fewer degrees of freedom (e.g., five degrees of freedom). According to the present embodiment, for example, when executing the teaching process, the operator can optionally designate one of the first control method MT1 with multiple degrees of freedom (six degrees of freedom) and the second control method MT2 with fewer degrees of freedom (five degrees of freedom).

On the other hand, in the operation of the robot 12 with fewer degrees of freedom (five degrees of freedom), there is a case where the end effector 28 cannot be positioned at any position unless the predetermined condition CD2 is satisfied. According to the present embodiment, when the condition determination unit 64 does not satisfy the condition CD2, the operation of the robot 12 with fewer degrees of freedom (five degrees of freedom) is prohibited, and on the other hand, when the condition CD2 is satisfied, the operation is permitted.

This configuration allows, by designating the second control method MT2 when the occurrence of the singular point SP is assumed in, for example, the teaching process, the operator to operate the robot 12 to any position without considering the singular point SP and can reliably avoid the operation of the robot 12 from becoming unstable due to the singular point SP. On the other hand, when no occurrence of the singular point SP is assumed, designating the first control method MT1 causes the robot 12 to execute the operation with multiple degrees of freedom (six degrees of freedom) and allows the robot 12 to smoothly operate.

In the device 60, the program setting unit 68 designates one of the first control method MT1 and the second control method MT2 in the operation program OPₘ in response to the input IN5 received by the input receiving unit 62 (steps S17 and S37). This configuration allows the operator to appropriately designate the control method MT when executing the operation program OPₘ from the first control method MT1 and the second control method MT2. The execution of the operation program OPₘ will be described later.

In the device 60, the operation command unit 66 causes the robot 12 to execute the operation according to the first control method MT1 or the second control method MT2 in response to the teaching command Ct (specifically, the jog command Ct1 or the handling force Ct2) for teaching the robot 12 the operation (steps S13 and S33). This configuration allows the operator to execute the teaching process by causing the robot 12 to operate in accordance with the first control method MT1 or the second control method MT2 optionally designated.

As an example of the device 60, the input receiving unit 62 further receives the input IN7 of the jog command Ct1 as the teaching command Ct, and the operation command unit 66 causes the robot to operate in response to the jog command Ct1 received by the input receiving unit 62. This configuration allows, in the teaching process, the operator to cause the robot 12 to perform the jog operation in accordance with the first control method MT1 or the second control method MT2 optionally designated.

As another example of the device 60, the operation command unit 66 acquires based on the detection data Df of the force sensor 34 detecting the force F applied to the robot 12, the handling force Ct2 applied to the robot 12 as the teaching command Ct and causes the robot 12 to operate in response to the handling force Ct2 (lead-through teaching function). This configuration allows, in the teaching process, the operator to cause the robot 12 to operate by the lead-through teaching function in accordance with the first control method MT1 or the second control method MT2 optionally designated.

In the device 60, the condition CD2 includes the condition CD2_{_1} (e.g., R4=0°) and the condition CD2_{_2} (e.g., the z axis of the MIF coordinate system C2 is in the vertical direction or the horizontal direction) for determining the position P of the robot 12. When the condition determination unit 64 determines that the condition CD2_{_1} or CD2_{_2} is not satisfied (NO in step S11), the operation command unit 66 positions the robot 12 at the position P′ that satisfies the condition CD2_{_1} or CD2₂ (step S22).

Thereafter, the operation command unit 66 causes the robot 12 to execute the operation by the second control method MT2 (step S13). This configuration allows, even if the robot 12 is arranged at the position P not satisfying the condition CD2_{_1} or CD2_{_2} at the time point of start of step S2, the position P of the robot 12 to be automatically adjusted so as to satisfy the condition CD2_{_1} or CD2_{_2}.

In the present embodiment, the input receiving unit 62 receives in steps S16 and S36 the input IN5 for designating one of the first control method MT1 and the second control method MT2, and the program setting unit 68 designates in steps S17 and S37, in the operation program OPₘ, one of the first control method MT1 and the second control method MT2 in response to the input IN5 having been received.

As a result, the operation program OPₘ that defines the operation of the robot 12 with multiple degrees of freedom and designates the first control method MT1 or the second control method MT2 is generated. Therefore, the input receiving unit 62 and the program setting unit 68 constitute a device 100 (FIG. 2) that generates the operation program OPₘ. According to the device 100, it is possible to create the operation program OPₘ to be executed by the first control method MT1 or the second control method MT2 optionally designated by the operator.

The processor 36 may execute the flow of FIG. 3 in accordance with the computer program PG1 stored in advance in the memory 38 (or 48). The functions of the devices 60 and 100 (the input receiving unit 62, the condition determination unit 64, the operation command unit 66, and the program setting unit 68) to be executed by the processor 36 may be function modules implemented by the computer program PG1.

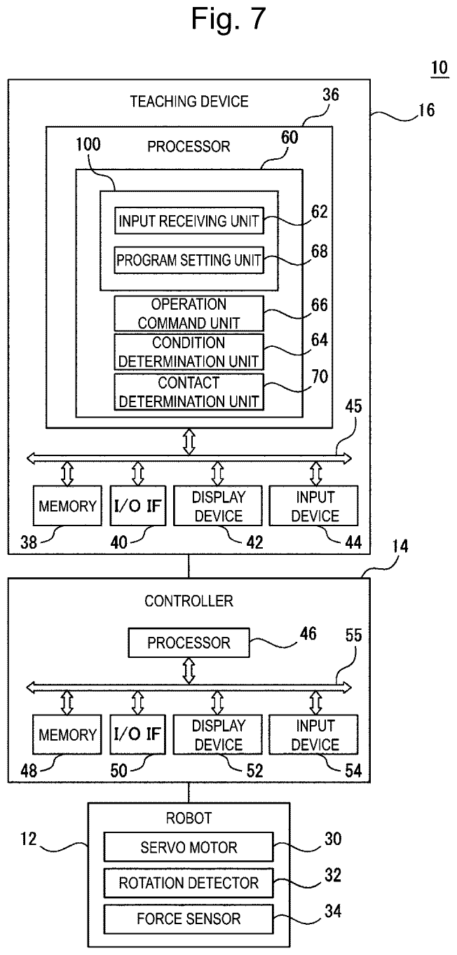

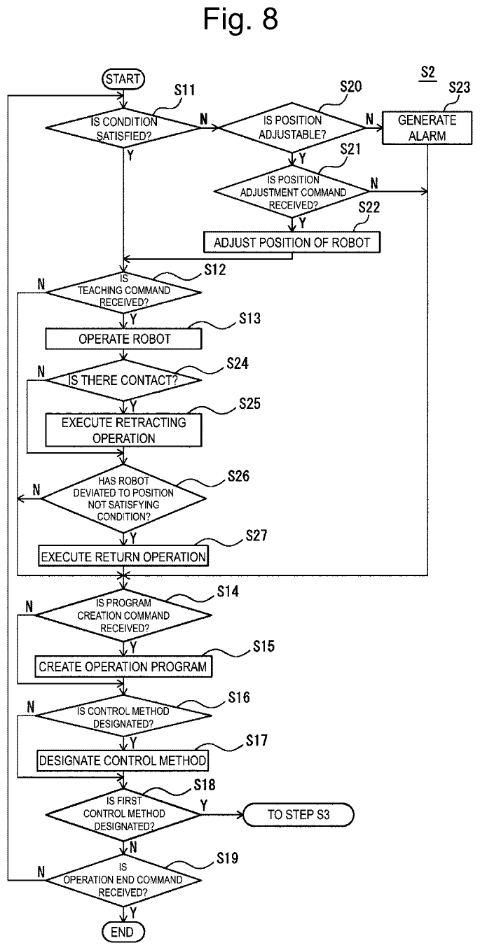

Next, other functions of the robot system 10 will be described with reference to FIGS. 7 and 8. In the present embodiment, the processor 36 of the teaching device 16 executes, as step S2 in FIG. 3, the flow illustrated in FIG. 8. In the flow illustrated in FIG. 8, processes similar to those in the flow of FIG. 4 are denoted by the same step numbers, and duplicate descriptions will be omitted. In the flow of FIG. 8, the processor 36 executes steps S24 to S27 after step S13.

Specifically, in step S24, the processor 36 determines, based on the detection data Df of the force sensor 34, whether or not the robot 12 contacts surroundings SR (e.g., the operator or a structure in a work cell). For example, the processor 46 of the controller 14 periodically acquires the detection data Df of the force sensor 34 during the execution of the operation of step S13 and monitors, based on the detection data Df, a contact force Fc applied to the robot 12 due to the robot 12 contacting the surroundings SR.

In step S24, the processor 36 of the teaching device 16 determines YES if the contact force Fc monitored by the controller 14 exceeds a predetermined threshold value Fth (Fc≥Fth). The processor 36 stops the operation of the robot 12 and proceeds to step S25 if determining YES but proceeds to step S26 if determining NO. In this manner, in the present embodiment, the processor 36 functions as a contact determination unit 70 (FIG. 7) that determines, based on the detection data Df, whether or not the robot 12 contacts the surrounding SR.

In step S25, the processor 36 functions as the operation command unit 66 and executes a retracting operation of retracting the robot 12. Specifically, as the retracting operation, the processor 36 moves the robot 12 by a predetermined distance from the position P at which the robot 12 is stopped (i.e., the position at which the contact with the surrounding SR has occurred) at the time point if determining YES in the immediately preceding step S24 to a direction MD″ (or a predetermined direction) opposite to the movement direction MD in which the robot 12 has been moved in the latest step S13.

The processor 36 may move the robot 12 (e.g., the end effector 28) by executing the joint motion SM in the retracting operation. At this time, even if the robot 12 is not brought into a state of satisfying the condition CD2, the processor 36 preferentially executes the retracting operation. In the retracting operation, the processor 36 may cause the robot 12 to operate at a velocity V′(<V) lower than the movement velocity V at which the robot 12 is moved in step S13.

In step S26, the processor 36 functions as the condition determination unit 64 to determine whether or not the robot 12 has deviated to the position P not satisfying the condition CD2 of the second control method MT2. Specifically, the processor 36 acquires the rotational position R4 of the fourth joint shaft A4 at this time point and the coordinates Q_{M} (w, p, r) indicating the orientation of the MIF coordinate system C2 at this time point similar to step S11 described above.

The processor 36 determines, based on the acquired rotational position R4, whether or not the condition CD2_{_1} (R4=0°) is still satisfied and determines whether or not the condition CD2_{_2} (the z axis of the MIF coordinate system C2 is in the vertical direction or the horizontal direction) is still satisfied based on the acquired coordinates Q_{M} (w, p, r). The processor 36 determines to be YES if at least one of the conditions CD2_{_1} and CD2_{_2} is not satisfied and proceeds to step S27 but determines to be NO if both of the conditions CD2_{_1} and CD2_{_2} are satisfied and proceeds to step S14.

In step S27, the processor 36 functions as the operation command unit 66 to execute a return operation of returning the robot 12 to the position P′ satisfying the condition CD2. Specifically, as the return operation, the processor 36 returns, based on the rotational position R4 and the coordinate Q used for the determination in the latest step S26, the robot 12 to the position P′ satisfying the condition CD2_{_1} (R4=0°) and the condition CD_{2_2} (the z axis of the MIF coordinate system C2 is in the vertical direction or the horizontal direction).

In this return operation, the processor 36 may change the position and orientation of the hand-tip portion (the wrist flange 26b and the end effector 28) of the robot 12. For example, it is assumed that step S27 is executed after step S25 is executed. In this case, the processor 36 stores, in the memory 48, coordinates Q_{T}^{′}(x, y, z) of the origin of the tool coordinate system C3 (or the MIF coordinate system C2) at the robot coordinate system C1 at the time point if determining YES in step S24 (or the time point at which the operation of the robot 12 is stopped).

In step S27, the processor 36 may move the end effector 28 (or the wrist flange 26b) from the position and orientation at this time point to an orientation satisfying the conditions CD2_{_1} and CD2_{_2} and to the position of coordinates Q_{T}^{′}(x, y, z). In step S27, the processor 36 may move the robot 12 to the teaching point Ptₙ stored in the memory 38 in the latest step S15.

In the return operation, the processor 36 may move the robot 12 by executing the joint motion SM described above. In the return operation, the processor 36 may cause the robot 12 to operate at the velocity V′ (<V) lower than the movement velocity V at which the robot 12 is moved in step S13. After step S27, the processor 36 proceeds to step S14.

As described above, in the present embodiment, the processor 36 functions as the input receiving unit 62, the condition determination unit 64, the operation command unit 66, the program setting unit 68, and the contact determination unit 70, and the input receiving unit 62, the condition determination unit 64, the operation command unit 66, the program setting unit 68, and the contact determination unit 70 constitute the device 60 (FIG. 7).

In the present embodiment, when the operation command unit 66 executes the operation in step S13, the contact determination unit 70 determines, based on the detection data Df of the force sensor 34, whether or not the robot 12 contacts the surrounding SR (step S24). If the contact determination unit 70 determines that the robot 12 contacts the surrounding SR (YES in step S24), the operation command unit 66 executes the retracting operation of retracting the robot 12 from the position P at which the contact has occurred (step S25). This configuration allows the contact between the robot 12 and the surrounding SR to be reliably eliminated by the retracting operation and can thus enhance the safety of the operation of the robot 12.

In the present embodiment, when the robot 12 deviates to the position P not satisfying the condition CD2 (CD2_{_1} and CD2_{_2}) when the operation of step S13 is executed, the operation command unit 66 executes the return operation of returning the robot 12 to the position P′ satisfying the condition CD2 (step S27). This configuration allows, when the position P of the robot 12 deviates due to contact of the robot 12 with the surrounding SR, forced movement of the robot 12 for ensuring safety by the operator, or the like, the robot 12 to be automatically returned to the position P′ satisfying the condition CD2.

Step S21 may be omitted from the flow of FIG. 4 or FIG. 8, and the processor 36 may automatically execute step S22 if determining YES in step S20. Alternatively, steps S20 to S22 may be omitted from the flow of FIG. 4 or FIG. 8, and the processor 36 may proceed to step S23 if determining NO in step S11.

Steps S26 and S27 may be omitted from the flow of FIG. 8. Alternatively, steps S24 and S25 may be omitted from the flow of FIG. 8, and the processor 36 may execute steps S26 and S27 after step S13. That is, in this case, the contact determination unit 70 can be omitted from the device 60 in FIG. 7. Steps S24 to S27 illustrated in FIG. 8 may be applied to step S3 illustrated in FIG. 6. For example, the processor 36 may execute steps S24 to S27 after step S33 in FIG. 6.

At least one of the functions (i.e., the input receiving unit 62, the condition determination unit 64, the operation command unit 66, the program setting unit 68, and the contact determination unit 70) of the device 60 may be mounted on the controller 14. For example, among the functions of the device 60, the functions of the condition determination unit 64, the operation command unit 66, and the contact determination unit 70 may be mounted on the controller 14. In this case, the processor 46 of the controller 14 functions as the condition determination unit 64, the operation command unit 66, and the contact determination unit 70 and executes steps S11, S13, S24 to S27, S22, S32, and S33 described above.

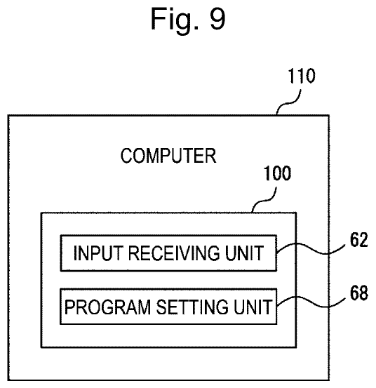

Only the functions of the device 100 can be mounted on another computer. Such a form is illustrated in FIG. 9. A computer 110 illustrated in FIG. 9 includes, for example, a processor (e.g., CPU or GPU), a memory (ROM or RAM), a display device (e.g., a liquid crystal display or an organic EL display), and an input device (e.g., a touch panel, a keyboard, or a mouse) (none of which are illustrated). The computer 110 may be a PC of a desktop type, a laptop type, or a tablet type, or may be the teaching device or the controller of the robot 12.

For example, the processor of the computer 110 acquires, from the teaching device 16, teaching data such as the teaching point Ptₙ, the movement path MP, and the movement velocity V having been taught using the teaching device 16. The processor of the computer 110 generates the operation program OP defining the acquired teaching data. The processor of the computer 110 functions as the input receiving unit 62 to receive the input IN5 for designating one of the first control method MT1 and the second control method MT2.

The processor of the computer 110 may function as the program setting unit 68 to designate, in the operation program OP, one of the first control method MT1 and the second control method MT2 in response to the input IN5 having been received. In this manner, while the function of the device 100 is mounted on the computer 110, the program setting unit 68 may be omitted from the device 60.

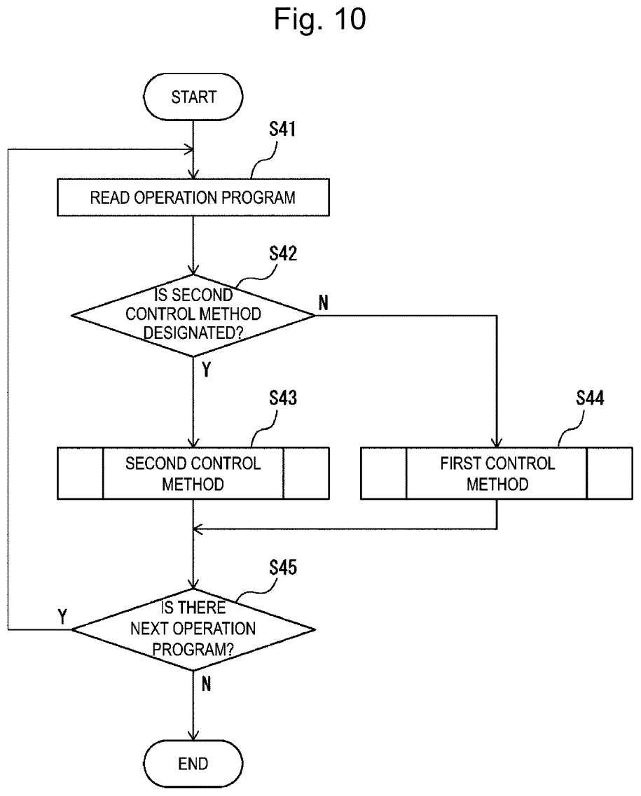

Next, other functions of the robot system 10 illustrated in FIG. 7 will be described. In the present embodiment, the processor 36 of the teaching device 16 executes the operation reproduction mode OM3 described above in order to perform an operation check of the operation program OPₘ created by the flow of FIG. 3. Specifically, the processor 36 executes the flow illustrated in FIG. 10 as the operation reproduction mode OM3. The processor 36 starts the flow of FIG. 10 when receiving an operation start command from the operator, the higher-level controller, or a computer program PG2.

In step S41, the processor 36 reads the operation program OPₘ. Here, in the present embodiment, the processor 36 sequentially reads the plurality of operation programs OP₁, OP₂, and OP₃, . . . created by the flow of FIG. 3 from the memory 38 (or 48) and continuously executes these programs.

An order OD to be executed may be predetermined in the plurality of operation programs OPₘ. In this case, the operator may operate the input device 44 to give an input IN8 defining the order OD, and the processor 36 may function as the program setting unit 68 to set the order OD in the operation program OPₘ having been created in response to the input IN8. Therefore, when executing the first step S41, the processor 36 reads, from the memory 38 (or 48), the operation program OP₁ given the order OD:“1”.

In step S42, the processor 36 determines whether or not the second control method MT2 is designated in the operation program OPₘ read in the immediately preceding step S41. Specifically, the processor 36 refers to the flag FL given to the operation program OPₘ having been read and determines whether or not the flag FL indicates designation of the second control method MT2. The processor 36 determines YES and proceeds to step S43 if the second control method MT2 is designated and determines NO and proceeds to step S44 if the first control method MT1 is designated.

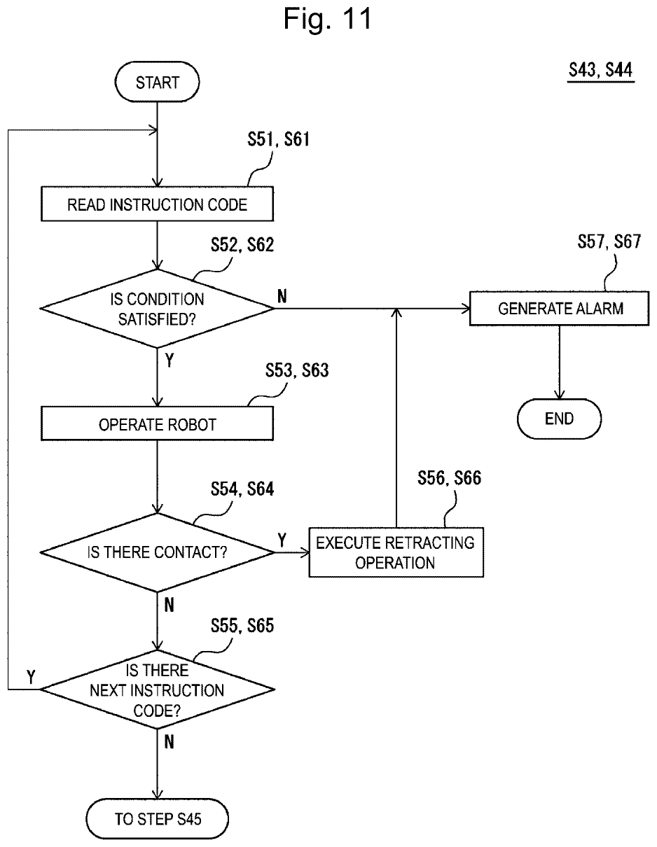

In step S43, the processor 36 executes an operation check process by the second control method MT2. This step S43 will be described with reference to FIG. 11. The processor 36 reads the instruction code IC:“START” on the first line defined in the operation program OPₘ read in the latest step S41 and starts the flow of step S43.

After the start of step S43, the processor 36 reads in step S51 the instruction code IC defined in the operation program OPₘ read in the latest step S41. Here, every time repeatedly executing step S51, the processor 36 reads the instruction code IC (FIG. 5) defined in the operation program OPₘ in the order of the second line, the third line, the fourth line, . . . .

In step S52, the processor 36 functions as the condition determination unit 64 to determine whether or not the condition CD2 of the second control method MT2 is satisfied. Specifically, the processor 36 analyzes the instruction code IC read in the immediately preceding step S51 and determines whether or not both of the conditions CD2_{_1} and CD2_{_2} are satisfied when the robot 12 is moved to the teaching point Ptₙ defined in the instruction code IC. The processor 36 determines to be YES if both of the conditions CD2_{_1} and CD2_{_2} are satisfied and proceeds to step S53 but determines to be NO if at least one of the conditions CD2_{_1} and CD2_{_2} is not satisfied and proceeds to step S57.

In step S53, the processor 36 functions as the operation command unit 66 and causes the robot 12 to execute the operation by the second control method MT2. Specifically, the processor 36 obtains the position P of the robot 12 (specifically, the end effector 28) at the robot coordinate system C1 from the rotational positions R1 to R3, R5, and R6 of the joint shafts A1 to A3, A5, and A6 using the second control program CP2 in order to execute the instruction code IC read in the immediately preceding step S51.

The processor 36 causes, based on the obtained position P, the robot 12 to execute the operation defined in the instruction code IC as the operation of the second control method MT₂ (i.e., five degrees of freedom). In step S54, the processor 36 functions as the contact determination unit 70 and determines whether or not the robot 12 contacts the surrounding SR similar to step S24 described above. The processor 36 proceeds to step S56 if determining to be YES but proceeds to step S55 if determining to be NO.

In step S55, the processor 36 determines whether or not there is the instruction code IC of the next line in the operation program OPₘ being executed. The processor 36 determines to be YES if the instruction code IC of the next line is not the instruction code IC:“END” of the i-th line in FIG. 5 and returns to step S51 but determines to be NO if the instruction code IC of the next line is the instruction code IC:“END” of the i-th line and proceeds to step S45 in FIG. 10. On the other hand, if determining YES in step S54, in step S56, the processor 36 functions as the operation command unit 66 to execute the retracting operation and then stop the robot 12 similar to step S25 described above. Thereafter, the processor 36 proceeds to step S57.

If determining NO in step S52 or when executing step S56, the processor 36 generates an alarm AL in step S57. For example, when executing step S57 after determining NO in step S52, the processor 36 generates and outputs, through the display device 42 or the speaker, an alarm AL4 of an image or audio that “The robot cannot be operated because the condition of the second control method is not satisfied. The robot needs to be retaught.” At this time, the processor 36 may attach, to the alarm AL1, information specifying the condition CD2 (the condition CD2_{_1} or CD2_{_2}) determined to be NO in the immediately preceding step S52.

On the other hand, when executing step S57 after step S56, the processor 36 generates and outputs, through the display device 42 or the speaker, the alarm AL5 of an image or audio that “The robot may contact surroundings, so it was retracted.” After step S57, the processor 36 ends the flow of step S43 illustrated in FIG. 11, thereby ending the flow of FIG. 10. In this manner, when the condition CD2 is not satisfied, the processor 36 does not execute the operation of the robot 12 by the second control method MT2 in step S53.

With reference to FIG. 10 again, if determining NO in step S42, the processor 36 executes in step S44 an operation check process by the first control method MT1. This step S44 will be described with reference to FIG. 11. In step S61 after the start of step S44, the processor 36 reads the instruction code IC defined in the operation program OPₘ read in the latest step S41 similar to the step S51 described above.

In step S62, the processor 36 functions as the condition determination unit 64 to determine whether or not the condition CD1 of the first control method MT1 is satisfied. Specifically, the processor 36 analyzes the instruction code IC read in the immediately preceding step S61 and determines whether or not the condition CD1 (not passing near the singular point SP) is satisfied when the robot 12 is moved to the teaching point Ptₙ defined in the instruction code IC. The processor 36 proceeds to step S63 if determining to be YES but proceeds to step S67 if determining to be NO.

In step S63, the processor 36 functions as the operation command unit 66 and causes the robot 12 to execute the operation by the first control method MT1. Specifically, the processor 36 obtains the position P of the robot 12 (the end effector 28) at the robot coordinate system C1 from the rotational positions R1 to R6 of the joint shafts A1 to A6 using the first control program CP1 in order to execute the instruction code IC read in the immediately preceding step S61.

The processor 36 causes, based on the obtained position P, the robot 12 to execute the operation defined in the instruction code IC as the operation of the first control method MT1 (i.e., six degrees of freedom). Thereafter, the processor 36 sequentially executes step S64 (contact determination) similar to step S53 described above, step S65 (next instruction code determination) similar to step S55 described above, and step S66 (retracting operation) similar to step S56 described above.

If determining NO in step S62 or when executing step S66, the processor 36 generates the alarm AL in step S67. For example, when executing step S67 after determining NO in step S62, the processor 36 generates and outputs, through the display device 42 or the speaker, an alarm AL6 of an image or audio that “The robot cannot be operated because the condition of the first control method is not satisfied. The robot needs to be retaught.” At this time, the processor 36 may attach, to the alarm AL6, information specifying the condition CD1 (passing near the singular point) determined to be NO in the immediately preceding step S62.

On the other hand, when executing step S67 after step S66, the processor 36 generates and outputs, through the display device 42 or the speaker, the alarm AL5 described above. After step S67, the processor 36 ends the flow of step S44 illustrated in FIG. 11, thereby ending the flow of FIG. 10. In this manner, when the condition CD1 is not satisfied, the processor 36 does not execute in step S63 the operation of the robot 12 by the first control method MT1.

With reference to FIG. 10 again, if determining NO in step S55 or S65 described above, the processor 36 determines in step S45 whether or not there is an operation program OPₘ₊₁ to be executed next. The processor 36 returns to step S41 if determining YES and executes, based on the operation program OPₘ₊₁, the flow of steps S42 to S45. On the other hand, if determining NO, the processor 36 ends the flow of FIG. 10.

Thus, the processor 36 sequentially executes the plurality of operation programs OPₘ created in the flow of FIG. 3 and operates the robot 12 in accordance with the first control method MT1 or the second control method MT2 designated in the operation program OPₘ in response to the input IN5 in step S17 or S37 described above. This enables the operator to check the operation defined in the operation program OPₘ.

As described above, in the present embodiment, the operation program OPₘ in which one of the first control method MT1 and the second control method MT2 is designated in step S17 or S37 is prepared in response to the input IN5 received by the input receiving unit 62 in step S16 or S36 described above. By executing the operation program OPₘ, the operation command unit 66 causes the robot 12 to execute the operation by the first control method MT1 or the second control method MT2 designated in the operation program OPₘ (step S53 or S63).

This operation program OPₘ is configured to define the operation of the robot 12 having multiple degrees of freedom (six degrees of freedom) and to be able to designate one of the first control method MT1 and the second control method MT2 (specifically, able to give the flag FL). The operation program OPₘ causes the robot 12 to execute the operation by the first control method MT1 or second control method MT2 having been designated.

This configuration allows the operator to optionally designate the first control method MT1 or the second control method MT2 in each operation program OPₘ in consideration of the operation of the operation program OPₘ created in the teaching process, allowing for reliably avoiding the operation of the robot 12 from becoming unstable due to, for example, the singular point SP described above when the operation program OPₘ is executed.

Since the control method MT is commanded for each operation program OPₘ, the robot 12 can be stably operated by the same control method MT also when the operation program OPₘ is interrupted in the middle (e.g., the third line in FIG. 5) and then resumed. This is advantageous in terms of stability of the operation of the robot 12 as compared with a case where the control method MT is switched during execution of one operation program.

Continuously executing the plurality of operation programs OPₘ with the control method MT designated individually enables various operations of the robot 12 for executing work and can switch the control method MT between the first control method MT1 and the second control method MT2 for each operation program OPₘ. Therefore, it is possible to flexibly cope with work requiring a wider variety of operations of the robot 12.

The processor 36 may execute the flow of FIG. 10 in accordance with the computer program PG2 stored in advance in the memory 38 (or 48). The function of the device 60 to be executed by the processor 36 may be a functional module implemented by the computer program PG2.

In step S51 or S61 of FIG. 11, the processor 36 may read the instruction codes IC of all the lines (i.e., the first line to the i-th line) defined in the operation program OPₘ and determine whether or not the condition CD2 or CD1 is satisfied for the operation defined in all the instruction codes IC in step S52 or S62. If determining YES in step S52 or S62, the processor 36 may sequentially execute all the instruction codes IC of the operation program OPₘ from the first line to the i-th line in step S53 or S63. In this case, step S55 or S65 can be omitted from the flow of FIG. 11.

In the robot system 10 illustrated in FIG. 7, the case where the processor 36 executes the flow illustrated in FIG. 3 to create the operation program OPₘ and then executes the flow illustrated in FIG. 10 to check the operation of the operation program OPₘ has been described. However, another computer (e.g., the computer 110 described above) may create the operation program OPₘ.

The processor 36 of the teaching device 16 may execute the flow illustrated in FIG. 10 in order to check the operation of the operation program OPₘ created by the other computer. In this case, the program setting unit 68 can be omitted from the device 60 in FIG. 7. Steps S54 and 56 may be omitted from the flow of FIG. 11. That is, in this case, the contact determination unit 70 can be omitted from the device 60 in FIG. 7.

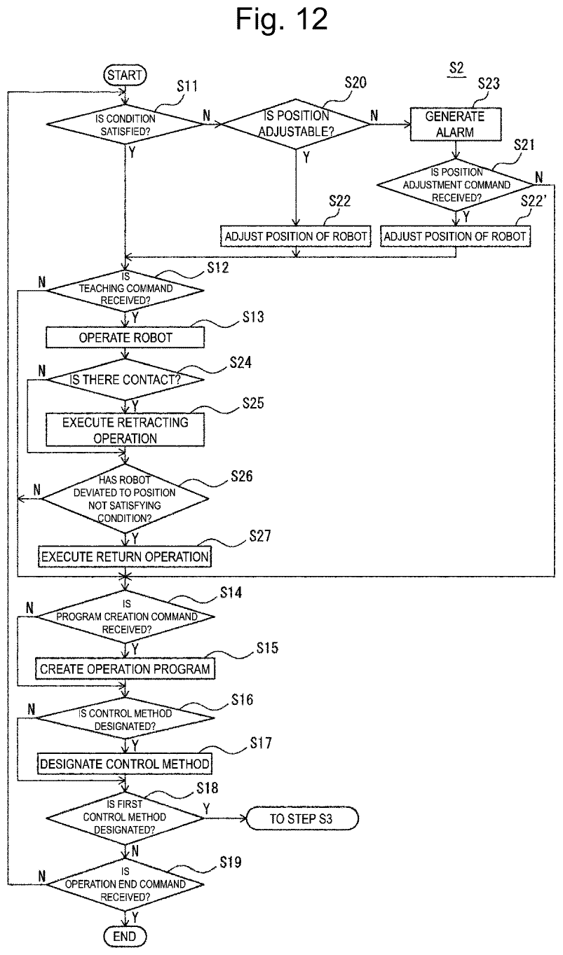

The flows illustrated in FIGS. 3, 4, 6, 8, 10, and 11 are examples, and various modifications can be made. FIG. 12 illustrates a modification of step S2 of FIG. 8. In the flow of FIG. 12, if determining YES in step S20, the processor 36 proceeds to step S22 and adjusts the current position Pc of the robot 12. On the other hand, after executing step S23, the processor 36 executes step S21 described above and determines whether or not the position adjustment command Ca has been received.

If determining YES in step S21 in FIG. 12, in step S22′, the processor 36 functions as the operation command unit 66 and adjusts the current position Pc of the robot 12 similar to step S22 described above. On the other hand, if determining NO in step S21 in FIG. 12, the processor 36 proceeds to step S14.

In this manner, in the flow of FIG. 12, even if determining NO in step S20, the processor 36 executes step S22′ and adjusts the current position Pc of the robot 12 if receiving the input IN3 of the position adjustment command Ca from the operator in step S21. This configuration can efficiently proceed the teaching process while securing the safety of the operator by preventing unintentionally operating.

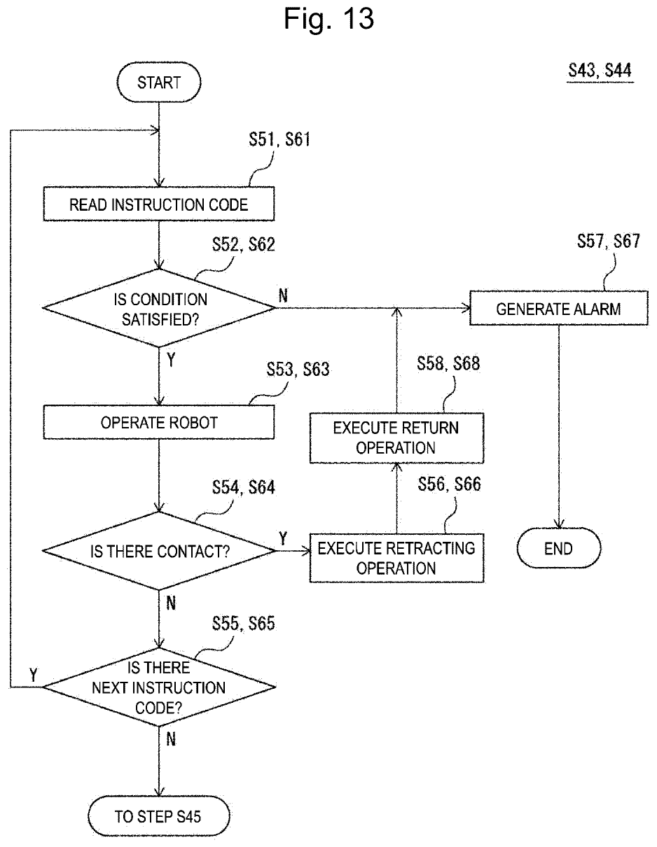

FIG. 13 illustrates a modification of steps S43 and S44 in FIG. 11. In step S43 illustrated in FIG. 13, the processor 36 executes step S58 after step S56. In step S58, the processor 36 functions as the operation command unit 66 to execute the return operation. Specifically, the processor 36 stores, in the memory 48, coordinates Q_{T}″ (x, y, z) of the origin of the tool coordinate system C3 (or the MIF coordinate system C2) at the robot coordinate system C1 at the time point if determining YES in the latest step S54 (or the time point at which the operation of the robot 12 is stopped).

In step S58, the processor 36 may move the end effector 28 (or the wrist flange 26b) from the position P at this time point to the position of the coordinates Q_{T}″ (x, y, z). Alternatively, in step S58, the processor 36 may move the robot 12 to the movement path MP defined in the operation program OPₘ being executed. Also in step S44 illustrated in FIG. 13, the processor 36 executes a similar return operation in step S68 after step S66. The processor 36 may execute step S56 (or S66) when a predetermined time has elapsed from the time point when the retracting operation of step S58 (or S66) was executed.

In the embodiment described above, the case where the condition CD2_{_1} of the second control method MT2 is R4 =0° has been described, but without limitation, and the condition CD2_{_1} may be defined as R4 =1800 ×α (α is any integer). In the embodiment described above, the second control method MT2 may include a plurality of control methods MT2_{_1}, MT2_{_2}, MT2_{_3}, . . . each defining the different condition CD2.

For example, in the control method MT2_{_1}, a condition CD2_{1_1} that R4 =0° and a condition CD2_{2_1} that the z axis direction of the MIF coordinate system C2 coincides vertically downward may be defined. In the control method MT2_{_2}, a condition CD2_{1_2} that R4 =180° and a condition CD2_{2_2} that the z axis direction of the MIF coordinate system C2 coincides vertically upward may be defined. In the control method MT2_{_3}, a condition CD2_{1_3} that R4=−180° and a condition CD2_{2_3} that the z axis direction of the MIF coordinate system C2 is parallel to the horizontal direction may be defined.

In this case, the processor 36 functions as the input receiving unit 62 and receives the inputs IN2 and IN5 for designating one of the control methods MT2_{_1}, MT2_{_2}, and MT2_{_3} as the second control method MT2 in steps S1, S16, and S38 described above. The processor 36 executes, based on the condition CD2 of the control method MT2_{_1}, MT2_{_2}, or MT2_{_3} having been designated, the steps S11, S13, S20, S22, S23, or S27 described above.

In step S17 described above, the processor 36 designates the control method MT2_{_1}, MT2_{_2}, or MT2_{_3} in the operation program OPₘ in response to the input IN5 having been received. This configuration allows the operator to designate, as the second control method MT2, the plurality of control methods MT2_{_1}, MT2_{_2}, and MT2_{_3} each defining various conditions CD2 (CD2_{_1_1}, CD2_{1_2}, CD2_{1_3}, CD2_{_2_1}, CD2_{_2_2}, and CD2_{_2 3}) are set, allowing for teaching a wider variety of operations.

In the embodiment described above, the case where the MIF coordinate system C2 and the tool coordinate system C3 are set at the robot 12 has been described. However, without limitation, and only one of the MIF coordinate system C2 and the tool coordinate system C3 may be set. For example, when the z axis of the tool coordinate system C3 is set to be parallel to (specifically, coincident with) the sixth joint shaft A6, the processor 36 may determine, based on the coordinate Q_{T} of the tool coordinate system C3 at the robot coordinate system C1 in steps S11 and S26 described above, the condition CD2 of the second control method MT2.

In the embodiment described above, the case where the first control method MT1 enables the operation of the robot 12 with six degrees of freedom and the second control method MT enables the operation of the robot 12 with five degrees of freedom has been described. However, the first control method MT1 may enable an operation with 7 or more degrees of freedom, for example, and the second control method MT may enable an operation with 4 or fewer degrees of freedom.

The condition CD2 of the second control method MT may include any other condition such as a condition that the robot 12 does not pass near the singular point SP or a condition that the robot 12 is within an allowable operation range. Similarly, the condition CD1 of the first control method MT1 may include any other condition. The robot 12 is not limited to a vertical articulated robot, but, for example, may be any type of robot such as a horizontal articulated robot or a parallel link robot.

The present disclosure has been described in detail above but is not limited to the above-described individual embodiments. These embodiments can be variously added, replaced, changed, partially deleted, and the like without departing from the gist of the present disclosure, or without departing from the gist of the present disclosure derived from the content described in the claims and equivalents thereof. These embodiments may also be combined. For example, in the above-described embodiments, the order of each operation and the order of each processing are illustrated as examples and are not limited to these orders. The same applies when numerical values or formula are used in the description of the above-described embodiments.

The present disclosure describes the following aspects.
(Aspect 1) A device 60 configured to control operation of a robot 12 having multiple degrees of freedom (e.g., six degrees of freedom), the device 60 including: an input receiving unit 62 configured to receive an input IN2, IN5, or IN6 for designating one of a first control method MT1 enabling the operation with multiple degrees of freedom and a second control method MT2 enabling the operation with one or more fewer degrees of freedom than those of the first control method MT1 (e.g., five degrees of freedom), a condition CD2 for permitting the operation by the second control method MT2 being predefined; an operation command unit 66 configured to cause the robot 12 to execute the operation by the first control method MT1 or the second control method MT2 designated by the input IN5 received by the input receiving unit 62; and a condition determination unit 64 configured to determine whether or not the condition CD2 is satisfied when the operation command unit 66 executes the operation by the second control method MT2, wherein the operation command unit 66 does not execute the operation by the second control method MT2 when the condition determination unit 64 determines that the condition CD2 is not satisfied.
(Aspect 2) The device 60 of aspect 1 further including an operation program OP in which one of the first control method MT1 and the second control method MT2 is designated in response to the input IN5 received by the input receiving unit 62, wherein the operation command unit 66 is configured to execute the operation program OP and cause the robot 12 to execute the operation by the first control method MT1 or the second control method MT2 designated in the operation program OP.
(Aspect 3) The device 60 of aspect 2 further including a program setting unit 68 configured to designate one of the first control method MT1 and the second control method MT2 in the operation program OP in response to the input IN5 received by the input receiving unit 62.
(Aspect 4) The device 60 of any of aspects 1 to 3, wherein the operation command unit 66 is configured to cause the robot to execute the operation by the first control method MT1 or the second control method MT2 in response to a teaching command Ct for teaching the operation.
(Aspect 5) The device 60 of aspect 4, wherein the input receiving unit 62 is configured to further receive an input IN7 of a jog command Ct1 as the teaching command Ct, and wherein the operation command unit 66 is configured to cause the robot 12 to execute the operation in response to the jog command Ct1 received by the input receiving unit 62.
(Aspect 6) The device 60 of aspect 4, wherein the operation command unit 66 is configured to: acquire a handling force Ct2 applied to the robot 12 as the teaching command Ct, based on detection data Df of a force sensor 34 configured to detect a force F applied to the robot 12; and cause the robot 12 to execute the operation in response to the handling force Ct2.
(Aspect 7) The device 60 of any of aspects 1 to 6, wherein the condition CD includes a condition CD2_{_1}, CD2_{_2}, CD2_{_1_1}, CD2_{_1_2}, CD2_{_1_3}, CD2_{_2_1}, CD2_{_2_2}, or CD2_{2 _3} for determining a position P of the robot 12, and wherein the operation command unit 66 is configured to: position the robot 12 at the position P′ at which the condition CD2 is satisfied, when the condition determination unit 64 determines that the condition CD2 is not satisfied; and subsequently cause the robot 12 to execute the operation by the second control method MT2.
(Aspect 8) The device 60 of any of aspects 1 to 7, wherein the condition CD2 includes a condition CD2_{_1}, CD2_{_2}, CD2_{_1_1}, CD2_{_1_2}, CD2_{_1_3}, CD2_{_2_1}, CD2_{_2_2}, or CD2_{2_3} for determining a position P of the robot 12, and wherein the operation command unit 66 is configured to execute a return operation of returning the robot 12 to the position P′ at which the condition CD2 is satisfied, when the robot 12 deviates to the position P at which the condition CD2 is not satisfied while executing the operation.
(Aspect 9) The device 60 of any of aspects 1 to 8 further including a contact determination unit 70 configured to determine whether or not the robot 12 contacts surroundings SR based on detection data Df of a force sensor 34 configured to detect a force F applied to the robot 12 when the operation command unit 66 executes the operation, wherein, when the contact determination unit 70 determines that the robot 12 contacts the surroundings SR, the operation command unit 66 is configured to execute a retracting operation of retracting the robot 12 from a position P at which the contact occurs.
(Aspect 10) The device 60 of any of aspects 1 to 9, wherein the second control method MT2 includes a plurality of control methods MT2_{_1}, MT2_{_2}, and MT2_{_3} for which the different condition CD2_{1_1}, CD2_{1_2}, CD2_{_1_3}, CD2_{_2_1}, CD2_{_2_2}, or CD2_{_2_3} are defined, and wherein the input receiving unit 62 is configured to receive an input IN2, IN5, or IN6 for designating one of the first control method MT1 and the plurality of control methods MT2_{_1}, MT2_{_2}, and MT2_{_3} as the second control method MT2.
(Aspect 11) A device 100 configured to generate an operation program OP defining operation of a robot 12 having multiple degrees of freedom (e.g., six degrees of freedom), the device 100 including: an input receiving unit 62 configured to receive an input IN5 for designating one of a first control method MT1 enabling the operation with multiple degrees of freedom and a second control method MT2 enabling the operation with one or more fewer degrees of freedom than those of the first control method MT1 (e.g., five degrees of freedom); and a program setting unit 68 configured to designate one of the first control method MT1 and the second control method MT2 in the operation program OP in response to the input IN5 received by the input receiving unit 62, the operation program OP causing the robot 12 to execute the operation by the first control method MT1 or the second control method MT2 designated by the program setting unit 68.
(Aspect 12) A method of controlling operation of a robot 12 having multiple degrees of freedom (e.g., six degrees of freedom), the method including: receiving, by a processor 36 or 46, an input IN2, IN5, or IN6 for designating one of a first control method MT1 enabling the operation with multiple degrees of freedom and a second control method MT2 enabling the operation with one or more fewer degrees of freedom than those of the first control method MT1 (e.g., five degrees of freedom), a condition CD2 for permitting the operation by the second control method MT2 being predefined; causing, by the processor 36 or 46, the robot 12 to execute the operation by the first control method MT1 or the second control method MT2 designated by the received input IN2, IN5, or IN6; determining, by the processor 36 or 46, whether or not the condition CD2 is satisfied when executing the operation by the second control method MT2; and not executing, by the processor 36 or 46, the operation by the second control method MT2 when determining that the condition CD2 is not satisfied.
(Aspect 13) A method of generating an operation program OP defining operation of a robot 12 having multiple degrees of freedom (e.g., six degrees of freedom), the method including: receiving, by a processor 36 or 46, an input IN5 for designating one of a first control method MT1 enabling the operation with multiple degrees of freedom and a second control method MT5 enabling the operation with one or more fewer degrees of freedom than those of the first control method MT1 (e.g., five degrees of freedom); and designating, by the processor 36 or 46, one of the first control method MT1 and the second control method MT2 in the operation program OP in response to the received input IN5, the operation program OP causing the robot 12 to execute the operation by the first control method MT1 or second control method MT2 designated.
(Aspect 14) A computer program PG1 or PG2 causing the processor 36 or 46 to execute the method of aspect 12 or 13.
(Aspect 15) An operation program OP defining operation of a robot 12 having multiple degrees of freedom (e.g., six degrees of freedom) and causing the robot 12 to execute the operation, the operation program OP being configured such that one of a first control method MT1 enabling the operation with multiple degrees of freedom and a second control method MT2 enabling the operation with one or more fewer degrees of freedom than those of the first control method MT1 (e.g., five degrees of freedom) is to be designated; wherein the operation program OP causes the robot 12 to execute the operation by the first control method MT1 or the second control method MT2 designated therein.

### REFERENCE SIGNS LIST

10 Robot system
12 Robot
14 Controller
16 Teaching device
36, 46 Processor
60, 100 Device
62 Input receiving unit
64 Condition determination unit
66 Operation command unit
68 Program setting unit
70 Contact determination unit
110 Computer

1. A device configured to control operation of a robot having multiple degrees of freedom, the device comprising:
an input receiving unit configured to receive an input for designating one of a first control method enabling the operation with multiple degrees of freedom and a second control method enabling the operation with one or more fewer degrees of freedom than those of the first control method, a condition for permitting the operation by the second control method being predefined;
an operation command unit configured to cause the robot to execute the operation by the first control method or the second control method designated by the input received by the input receiving unit; and
a condition determination unit configured to determine whether or not the condition is satisfied when the operation command unit executes the operation by the second control method,
wherein the operation command unit does not execute the operation by the second control method when the condition determination unit determines that the condition is not satisfied.

2. The device of claim 1, further comprising an operation program in which one of the first control method and the second control method is designated in response to the input received by the input receiving unit,
wherein the operation command unit is configured to execute the operation program and cause the robot to execute the operation by the first control method or the second control method designated in the operation program.

3. The device of claim 2, further comprising a program setting unit configured to designate one of the first control method and the second control method in the operation program in response to the input received by the input receiving unit.

4. The device of claim 1, wherein the operation command unit is configured to cause the robot to execute the operation by the first control method or the second control method in response to a teaching command for teaching the operation.

5. The device of claim 4, wherein the input receiving unit is configured to further receive an input of a jog command as the teaching command, and
wherein the operation command unit is configured to cause the robot to execute the operation in response to the jog command received by the input receiving unit.

6. The device of claim 4, wherein the operation command unit is configured to:
acquire a handling force applied to the robot as the teaching command, based on detection data of a force sensor configured to detect a force applied to the robot; and
cause the robot to execute the operation in response to the handling force.

7. The device of claim 1, wherein the condition includes a condition for determining a position of the robot, and
wherein the operation command unit is configured to:
position the robot at the position at which the condition is satisfied, when the condition determination unit determines that the condition is not satisfied; and
subsequently, cause the robot to execute the operation by the second control method.

8. The device of claim 1, wherein the condition includes a condition for determining a position of the robot, and
wherein the operation command unit is configured to execute a return operation of returning the robot to the position at which the condition is satisfied, when the robot deviates to the position at which the condition is not satisfied while executing the operation.

9. The device of claim 1, further comprising a contact determination unit configured to determine whether or not the robot contacts surroundings based on detection data of a force sensor configured to detect a force applied to the robot, when the operation command unit executes the operation,
wherein, when the contact determination unit determines that the robot contacts the surroundings, the operation command unit is configured to execute a retracting operation of retracting the robot from a position at which the contact occurs.

10. The device of claim 1, wherein the second control method includes a plurality of control methods, for which the different conditions are defined, and
wherein the input receiving unit is configured to receive an input for designating one of the first control method and the plurality of control methods as the second control method.

11. A device configured to generate an operation program defining operation of a robot having multiple degrees of freedom, the device comprising:
an input receiving unit configured to receive an input for designating one of a first control method enabling the operation with multiple degrees of freedom and a second control method enabling the operation with one or more fewer degrees of freedom than those of the first control method; and
a program setting unit configured to designate one of the first control method and the second control method in the operation program in response to the input received by the input receiving unit, the operation program causing the robot to execute the operation by the first control method or the second control method designated by the program setting unit.

12. A method of controlling operation of a robot having multiple degrees of freedom, the method comprising:
receiving, by a processor, an input for designating one of a first control method enabling the operation with multiple degrees of freedom and a second control method enabling the operation with one or more fewer degrees of freedom than those of the first control method, a condition for permitting the operation by the second control method being predefined;
causing, by the processor, the robot to execute the operation by the first control method or the second control method designated by the received input;
determining, by the processor, whether or not the condition is satisfied when executing the operation by the second control method; and
not executing, by the processor, the operation by the second control method when determining that the condition is not satisfied.

13. A method of generating an operation program defining operation of a robot having multiple degrees of freedom, the method comprising:
receiving, by a processor, an input for designating one of a first control method enabling the operation with multiple degrees of freedom and a second control method enabling the operation with one or more fewer degrees of freedom than those of the first control method; and
designating, by the processor, one of the first control method and the second control method in the operation program in response to the received input, the operation program causing the robot to execute the operation by the first control method or second control method designated.

14. A computer-readable non-transitory recording medium configured to record a computer program causing the processor to execute the method of claim 12.

15. An operation program defining operation of a robot having multiple degrees of freedom and causing the robot to execute the operation, the operation program being configured such that one of a first control method enabling the operation with multiple degrees of freedom and a second control method enabling the operation with one or more fewer degrees of freedom than those of the first control method is to be designated,
wherein the operation program causes the robot to execute the operation by the first control method or the second control method designated therein.

16. A computer-readable non-transitory recording medium configured to record a computer program causing the processor to execute the method of claim 13.
